(19) United States
(12) Patent Application Publication
(10) Pub. No.: US 2018/0330369 A1
(43) Pub. Date: Nov. 15, 2018

(54) AUTHENTICATION FOR MOBILE PAYMENTS USING SEPARATE SIGNATURES STORED ON AT LEAST ONE EXTERNAL SIGNATURE DEVICE CONTROLLED BY SWAPPABLE PERMISSION MODULES

(71) Applicant: Medici Ventures, Inc., Midvale, UT (US)

(72) Inventor: Andrew Warner, Midvale, UT (US)

(73) Assignee: Medici Ventures, Inc., Midvale, UT (US)

(21) Appl. No.: 15/975,625

(22) Filed: May 9, 2018

Related U.S. Application Data
(60) Provisional application No. 62/503,841, filed on May 9, 2017.

(51) Int. Cl. G06Q 20/38; G06Q 20/32; G06Q 20/10; G06Q 20/36

(52) U.S. Cl. CPC G06Q 20/3825; G06Q 20/3229; G06Q 20/36; G06Q 20/3278; G06Q 20/3829; G06Q 20/102

(57) ABSTRACT

A system includes a computing device and a first external signing device wirelessly communicatively coupled to the computing device. The computing device is configured to: receive a request to initiate payment from a mobile wallet; and wirelessly transmit unsigned transaction details to the first external signing device. The first external signing device is configured to: determine whether the unsigned transaction details meet restrictions set by any removable permission module inserted into the first external signing device; and when the unsigned transaction details meet the restrictions set by any removable permission module inserted into the first external signing device: wirelessly transmit a first signature to the computing device.

### CROSS-REFERENCE TO RELATED APPLICATIONS

This application claims the benefit of U.S. Provisional Patent Application Ser. No. 62/503,841 filed on May 9, 2017, entitled “AUTHENTICATION FOR MOBILE PAYMENTS USING SEPARATE SIGNATURES STORED ON AT LEAST ONE EXTERNAL SIGNATURE DEVICE CONTROLLED BY SWAPPABLE PERMISSION MODULES”, which is hereby incorporated herein by reference.

### BACKGROUND

Cryptography can be used to securely store and transmit data. Keys can be used to encrypt and decrypt data or to sign transactions. Payments from mobile wallets can be facilitated using computing devices implementing cryptography.

### SUMMARY

A system includes a computing device and a first external signing device wirelessly communicatively coupled to the computing device. The computing device is configured to: receive a request to initiate payment from a mobile wallet; and wirelessly transmit unsigned transaction details to the first external signing device. The first external signing device is configured to: determine whether the unsigned transaction details meet restrictions set by any removable permission module inserted into the first external signing device; and when the unsigned transaction details meet the restrictions set by any removable permission module inserted into the first external signing device: wirelessly transmit a first signature to the computing device.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is block diagram of an exemplary embodiment of a system including a computing device and an external signature device;

FIG. 2 is a block diagram of an exemplary embodiment of the computing device of FIG. 1;

FIG. 3 is a block diagram of an exemplary embodiment of the external signature device of FIG. 1;

FIG. 4A is a block diagram of an exemplary embodiment of a system including a computing device and a plurality of external signature devices using a multi-party key split methodology;

FIG. 4B is a block diagram of an exemplary embodiment of a system including a computing device and a plurality of external signature devices using a multi-party multiple signature (multi sig) methodology;

FIG. 5 is a flow diagram of an exemplary method for signing transactions using an external signature device having removable permission modules;

FIG. 6 is a flow diagram of an exemplary method for signing transactions using two external signature devices using a multi-party key split methodology;

FIG. 7 is a flow diagram of an exemplary method for signing transactions using two external signature devices using a multi-party multiple signature (multi sig) methodology; and

FIG. 8 illustrates an example of a computer system with which some embodiments of the present disclosure may be utilized.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Computing devices used for transacting using mobile wallets can be stolen. If private keys for the mobile wallets are stored on stolen computing device, the private key can be compromised. Computing devices used for transacting using mobile wallets can also be compromised by rogue applications, viruses, etc. that may be able to relay the private key to an external party, thus compromising the users entire wallet and funds. The embodiments described below relate to using external signature devices with a computing device (such as a mobile computing device) to sign transactions. In exemplary embodiments, the transactions are payment transactions using a cryptocurrency, block-chain, or other distributed ledger. By moving the private key to an external signature device (such as a bracelet, ring, etc.) that wirelessly communicates signatures with the computing device, funds of a wallet owner can only be spent when the external signature device is in possession of a user. In addition, removable permission modules for the external signature device can be used to place limitations/restrictions on transactions to be signed using the external signature device. In exemplary embodiments, where the external signature device uses close proximity limited wireless communication with the computing device, when a transaction is initiated it can be signed by holding the mobile computing device in close proximity to the external signature device.

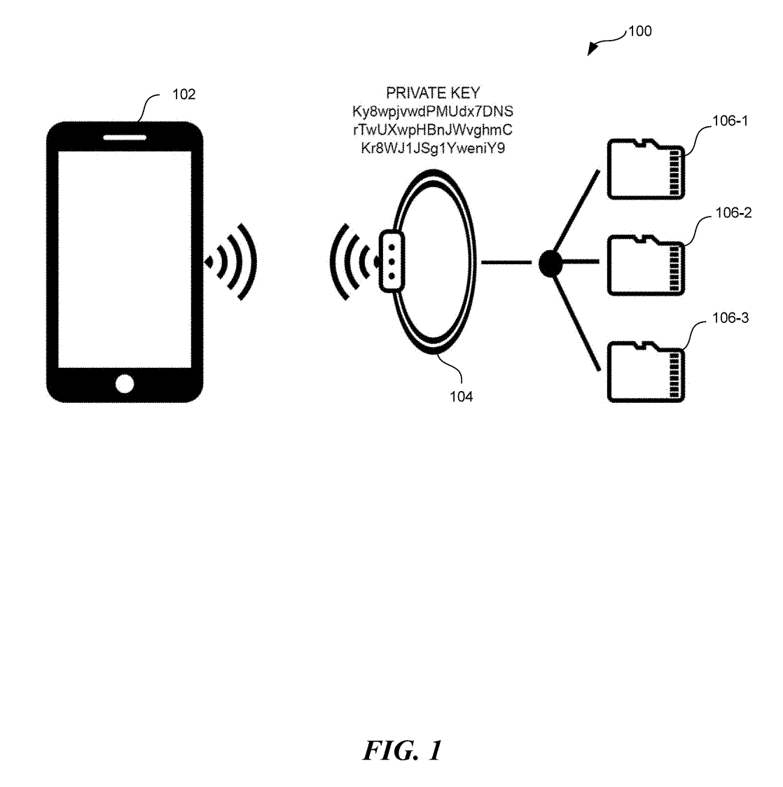

FIG. 1 is block diagram of a system 100 including a computing device 102 and an external signature device 104. In exemplary embodiments, the computing device 102 is a mobile computing device, such as a mobile phone, tablet computer, mobile media device, mobile gaming device, laptop computer, vehicle-based computer, etc. In other embodiments, the computing device 102 is a non-mobile device such as a dedicated terminal, a public terminal, a kiosk, a server, or a desktop computer. In exemplary embodiments, the external signature device 104 is a bracelet, ring, other jewelry, or credit card type device configured for communication with the computing device 102. In exemplary embodiments, the external signature device 104 communicates with the computing device 102 using limited proximity wireless communication that is limited to close proximity communication (such as a within several centimeters or inches), such as a passive near field communication (NFC) tag, an active near field communication (NFC) tag, a passive radio frequency identification (RFID) tag, an active radio frequency identification (RFID) tag, Bluetooth device (such as a Bluetooth Low Energy (BLE) device), and a proximity card.

The external signature device 104 is configured to receive removable permission modules 106. In exemplary embodiments, the removable permission modules 106 are memory cards configured for storing digitally stored data. In exemplary embodiments, the external signature device 104 includes at least one slot for inserting and removing the removable permission modules 106. Exemplary embodiments of memory cards for removable permission modules 106 include, but are not limited to, a Secure Digital Card (SD card), miniSD card, microSD card, SDHC, etc.), Compact Flash card, Smart Card, and Subscriber Identity Module (SIM) card.

In exemplary embodiments, the removable permission modules 106 store data regarding various permissions for transactions, such as maximum spend amounts per transaction, maximum spend amounts over a period of time per (such as a minute, hour, day, month, year, or other duration), maximum quantity of transactions within a particular period of time (such as a minute, hour, day, month, year, or other duration), restricted recipients or senders for transactions, restricted time for transaction (such as particular time of day, day of the week, month, year, and other ranges). Other restrictions and combinations thereof can be set on the transactions using the removable permission modules and the permission modules can be swapped out for different users and use cases of the external signature device 104 to limit potential misuse or unintended use of the external signature device 104. For example, a parent may provide a child with a particular permission module for day to day transactions. In exemplary embodiments, the external signature device 104 may have default permissions for when a removable permission module 106 is not inserted into the external signature device. In exemplary embodiments, the default settings would potentially only allow relatively small transaction amounts, while permission modules could allow greater transactions amounts. In other exemplary embodiments, the external signature device may limit any transactions without a removable permission module 106 present.

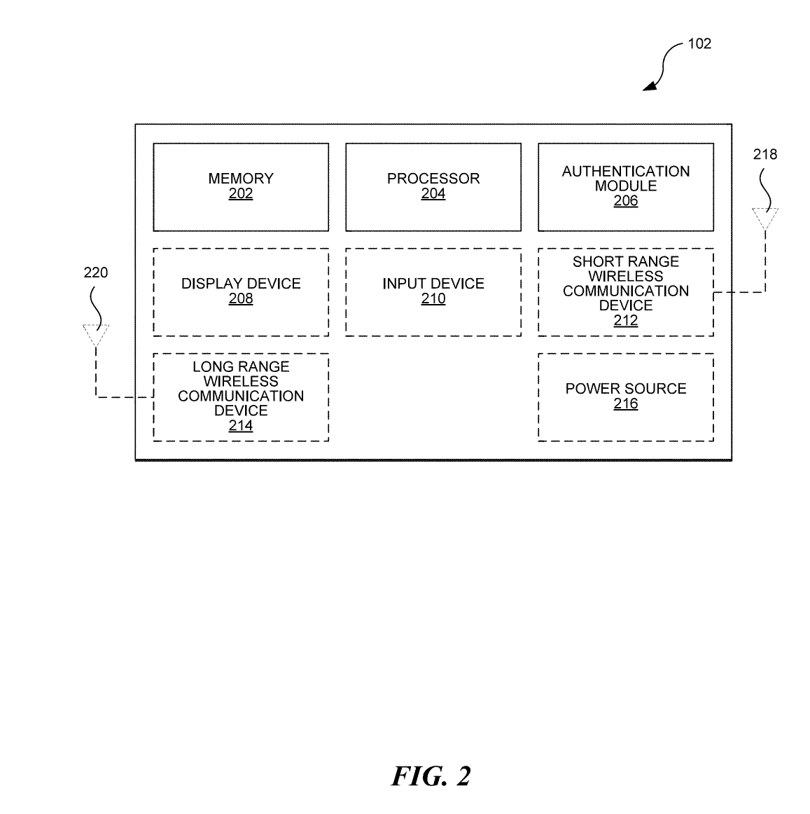

FIG. 2 is a block diagram of an exemplary embodiment of the computing device 102 including at least one memory 202, at least one processor 204, at least one authentication module 206, at least one optional display device 208, at least one optional input device 210, at least one optional short range wireless communication device 212, at least one optional long range wireless communication device 214, and at least one optional power source 216.

In exemplary embodiments, the at least one memory 202 can be any device, mechanism, or populated data structure used for storing information. In exemplary embodiments, the at least one memory 202 can be or include any type of volatile memory, nonvolatile memory, and/or dynamic memory. For example, the at least one memory 202 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 202 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as the at least one memory 202. The at least one memory 202 may be used to store instructions for running one or more applications or modules on the at least one processor 204. For example, the at least one memory 202 could be used in one or more embodiments to house all or some of the instructions needed to execute the functionality of the at least one authentication module 206.

In exemplary embodiments, the at least one processor 204 can be any known processor, such as a general purpose processor (GPP) or special purpose (such as a field-programmable gate array (FPGA), application-specific integrated circuit (ASIC) or other integrated circuit or circuitry), or any programmable logic device. In exemplary embodiments, the at least one authentication module 206 is implemented by the at least one processor 204 and the at least one memory 202.

In exemplary embodiments, the at least one optional display device 208 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), and a plasma display. In exemplary embodiments, the at least one optional input device 210 include at least one of a touchscreen (including capacitive and resistive touchscreens), a touchpad, a capacitive button, a mechanical button, a switch, a dial, a keyboard, a mouse, a camera, a biometric sensor/scanner, etc. In exemplary embodiments, the at least one optional display device 208 and the at least one optional input device 210 are combined into a human machine interface (HMI) for user interaction with the computing device 102.

In exemplary embodiments, the at least one optional short range wireless communication device 212 includes or is coupled to at least one optional antenna 218 for communication with at least one external signature device 104. In exemplary embodiments, the at least one optional short range wireless communication device 212 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device. In exemplary embodiments, the same at least one optional short range wireless communication device 212 is also used for communication with an external gateway device to a network (such as an NFC payment terminal).

The short range wireless communication device(s) are used for communication with the external signature device 104. In exemplary embodiments, use of proximity limited wireless communication is deliberate and enables increased security based on proximity by avoiding other devices from interrogating the external signature device 104. Accordingly, a device would need to be in close proximity to attempt to intercept the communication between the computing device 102 and the external signature device 104. While other communication, such as wired and/or optical communication could also be used, there are advantages with using the close proximity wireless communication over these alternatives. For example, wired communication is less convenient than wireless communication. Also, optical codes, such as QR codes, bar codes, etc. are less secure means for communicating keys and don't enable the same level of verification of information as using a close proximity wireless protocol.

In exemplary embodiments, the at least one optional long range wireless communication device 214 includes or is coupled to at least one optional antenna 220 for communication with a network. In exemplary embodiments, the at least one optional long range wireless communication device 214 include at least one of a cellular radio access technology radio and a WiFi radio. In exemplary embodiments, the at least one optional long range wireless communication device 214 includes a cellular radio access technology radio configured to establish a cellular data connection (mobile internet) of sufficient speeds with a remote server using a local area network (LAN) or a wide area network (WAN). In exemplary embodiments, the cellular radio access technology includes at least one of Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G), fourth generation (4G), fifth generation (5G), etc. or other appropriate communication services or a combination thereof. In exemplary embodiments, the at least one optional long range wireless communication device 214 includes a WiFi (IEEE 802.11) radio configured to communicate with a wireless local area network that communicates with the remote server, rather than a wide area network.

In exemplary embodiments, at least one optional power source 216 is used to provide power to the various components of the computing device 102.

The computing device 102 is configured to receive a request to initiate payment from a user. In exemplary embodiments, the payment is to be initiated from a mobile wallet (or mobile wallets) for a cryptocurrency stored in a block-chain or other distributed ledger. In other embodiments, the payment is to be initiated using another type of payment system or network. In exemplary embodiments, the at least one optional input device 210 and the at least one optional display device 208 are used by a user to receive the request to initiate payment.

The computing device 102 is configured to wirelessly transmit unsigned transaction details to at least one external signature device 104. In exemplary embodiments, the at least one authentication module 206 is configured to generate the unsigned transaction details from the request to initiate payment received at the computing device 102. In exemplary embodiments, the at least one authentication module 206 is configured to transmit the unsigned transaction details to the at least one external signature device 104 using the at least one optional short range wireless communication device 212 and the at least one optional antenna 218.

The computing device 102 is further configured to wirelessly receive any signatures (separately or as part of signed transactions) and/or any error messages from the at least one external signature device 104. In exemplary embodiments, the at least one authentication module 206 is configured to receive any signatures (separately or as part of signed transactions) and/or any error messages from the at least one external signature device 104 using the at least one optional short range wireless communication device 212 and the at least one optional antenna 218. In exemplary embodiments, error messages are sent by the at least one external signature device 104 when the transaction is not signed for a number of reasons, such as when the at least one external signature device 104 is not properly paired with the computing device 102 and/or when the transaction details do not meet the limitations set by any removable permission module inserted into the at least one external signature device 104.

The computing device 102 is further configured to submit the signed transaction to a network. In exemplary embodiments, the at least one authentication module 206 is configured to transmit the signed transaction to a network using the at least one optional long range wireless communication device 214 and the at least one optional antenna 220, such as via a cellular or WiFi network. In other exemplary embodiments, the at least one authentication module 206 is configured to transmit the signed transaction to a network using the at least one optional short range wireless communication device 212 and the at least one optional antenna 218, such as via NFC to a NFC payment terminal.

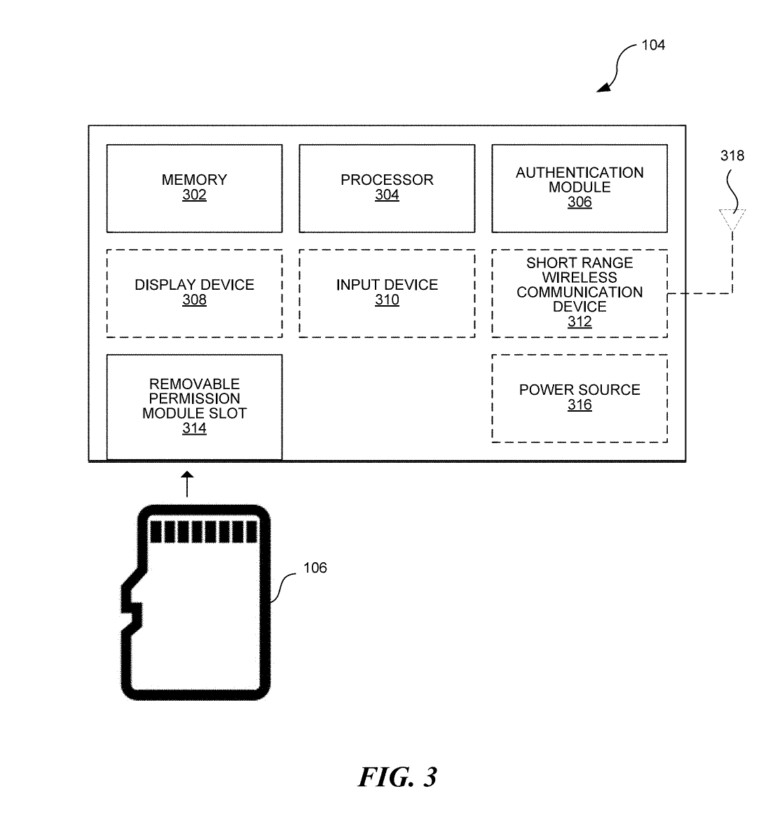

FIG. 3 is a block diagram of an exemplary embodiment of the external signature device 104 including at least one memory 302, at least one processor 304, at least one authentication module 306, at least one optional display device 308, at least one optional input device 310, at least one optional short range wireless communication device 312, at least one removable permission module slot 314, and at least one optional power source 316.

In exemplary embodiments, the at least one memory 302 can be any device, mechanism, or populated data structure used for storing information. In exemplary embodiments, the at least one memory 302 can be or include any type of volatile memory, nonvolatile memory, and/or dynamic memory. For example, the at least one memory 302 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 302 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as the at least one memory 302. The at least one memory 302 may be used to store instructions for running one or more applications or modules on the at least one processor 304. For example, the at least one memory 302 could be used in one or more embodiments to house all or some of the instructions needed to execute the functionality of the authentication module 306.

In exemplary embodiments, the at least one processor 304 can be any known processor, such as a general purpose processor (GPP) or special purpose (such as a field-programmable gate array (FPGA), application-specific integrated circuit (ASIC) or other integrated circuit or circuitry), or any programmable logic device. In exemplary embodiments, the at least one authentication module 206 is implemented by the at least one processor 204 and the at least one memory 202.

In exemplary embodiments, the at least one optional display device 308 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), and a plasma display. In exemplary embodiments, the at least one optional input device 310 include at least one of a touchscreen (including capacitive and resistive touchscreens), a touchpad, a capacitive button, a mechanical button, a switch, a dial, a keyboard, a mouse, a camera, a biometric sensor/scanner, etc. In exemplary embodiments, the at least one optional display device 308 and the at least one optional input device 310 are combined into a human machine interface (HMI) for user interaction with the external signature device 104. In exemplary embodiments, no display devices or input devices are used to simplify the external signature device 104, such as when the external signature device 104 is a bracelet, ring, other jewelry, or credit card type device.

In exemplary embodiments, the at least one optional short range wireless communication device 312 includes or is coupled to at least one optional antenna 318 for communication with the computing device 102. In exemplary embodiments, the at least one optional short range wireless communication device 312 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device. The short range wireless communication device(s) are used for communication with the computing device 102. In exemplary embodiments, use of proximity limited wireless communication is deliberate and enables increased security based on proximity by avoiding other devices from interrogating the external signature device 104. Accordingly, a device would need to be in close proximity to attempt to intercept the communication between the computing device 102 and the external signature device 104.

The short range wireless communication device(s) are used for communication with the computing device 102. In exemplary embodiments, use of proximity limited wireless communication is deliberate and enables increased security based on proximity by avoiding other devices from interrogating the external signature device 104. Accordingly, a device would need to be in close proximity to attempt to intercept the communication between the computing device 102 and the external signature device 104. While other communication, such as wired and/or optical communication could also be used, there are advantages with using the close proximity wireless communication over these alternatives. For example, wired communication is less convenient than wireless communication. Also, optical codes, such as QR codes, bar codes, etc. are less secure means for communicating keys and don't enable the same level of verification of information as using a close proximity wireless protocol. In exemplary embodiments, optional long range wireless communications devices are included in the external signature device 104, though such inclusion could be a disadvantage from a security standpoint.

In exemplary embodiments, the at least one removable permission module slot 314 is configured receive removable permission modules 106. The removable permission modules 106 can be inserted into the at least one removable permission module slot 314 and subsequently removed from the at least one removable permission module slot 314 and replaced with a different removable permission module 106. In exemplary embodiments, the at least one removable permission module slot 314 includes at least one of a Secure Digital Card (SD card) slot, miniSD card slot, microSD card slot, SDHC slot, etc.), Compact Flash card slot, Smart Card slot, and Subscriber Identity Module (SIM) card slot. In exemplary embodiments, limitations on transactions are stored on the removable permission modules 106 and the authentication module 306 can limit providing signatures for (and/or signing) of transactions to transactions that meet the limitations on transactions stored on the removable permission modules 106.

In exemplary embodiments, the at least one optional power source 316 is used to provide power to the various components of the external signature device 104.

In exemplary embodiments, the external signature device 104 is configured to wirelessly receive the unsigned transaction details from the computing device 102. In exemplary embodiments, the authentication module 306 is configured to receive the unsigned transaction details from the computing device 102 using the at least one optional short range wireless communication device 312 and the at least one optional antenna 318.

The external signature device 104 is configured to determine whether the unsigned details meet restrictions set by any removable permission module 106 inserted into the first external signature device 104. In exemplary embodiments, the authentication module 306 is configured to compare the unsigned details with any restrictions set by any removable permission module 106 inserted into the at least one removable permission module slot 314 of the external signature device 104. In addition, the external signature device 104 is optionally configured to determine whether the external signature device 104 is paired with the computing device 102. In exemplary embodiments, the external signature device 104 provides signatures to the computing device 102. In exemplary embodiments, the external signature device 104 (such as through the authentication module 306) is configured to transmit a first signature to the computing device 102 when it is determined that (1) the unsigned transaction details meet the restrictions set by any removable permission module 106 inserted into the first external signature device 104; and (2) the external signature device 104 is paired with the computing device 102. In exemplary embodiments, the external signature device 104 (such as through the authentication module 306) is configured to at least one of not sign the transaction, not transmit the first signature to the computing device 102 (separately or as part of a signed transaction), and generate an error message for the computing device 102 when it is determined that (1) the unsigned transaction details do not meet the restrictions set by any removable permission module 106 inserted into the first external signature device 104; or (2) the external signature device 104 is not paired with the computing device 102.

In exemplary embodiments, the external signature device 104 signs transactions with a signature and provides the signed transactions to the computing device 102. In exemplary embodiments, the external signature device 104 (such as through the authentication module 306) is configured to sign the unsigned transaction using a first signature to generate a signed transaction by signing the unsigned transaction using a first signature when it is determined that (1) the unsigned transaction details meet the restrictions set by any removable permission module 106 inserted into the first external signature device 104; and (2) the external signature device 104 is paired with the computing device 102. In exemplary embodiments, the external signature device 104 (such as through the authentication module 306) is configured to at least one of not sign the unsigned transaction and generate an error message for the computing device 102 when it is determined that (1) the unsigned transaction details do not meet the restrictions set by any removable permission module 106 inserted into the first external signature device 104; or (2) the external signature device 104 is not paired with the computing device 102.

In exemplary embodiments, the removable permission modules 106 store data regarding various restrictions for transactions, such as maximum spend amounts per transaction, restricted recipients for transactions, restricted time for transaction (such as particular time of day, day of the week, month, year, etc. ranges). Other restrictions and combinations thereof can be set on the transactions using the removable permission modules and the permission modules can be swapped out for different users and use cases of the external signature device 104 to limit potential misuse or unintended use of the external signature device 104. For example, a parent may provide a child with a particular permission module for day to day transactions. In exemplary embodiments, the external signature device 104 may have default permissions for when a removable permission module 106 is not inserted into the external signature device. In exemplary embodiments, the default settings would potentially only allow relatively small transaction amounts, while permission modules could allow greater transactions amounts. In other exemplary embodiments, the external signature device may limit any transactions without a removable permission module 106 present.

The external signature device 104 is configured to wirelessly transmit the signed transaction or any error messages to the computing device 102. In exemplary embodiments, the authentication module 306 is configured to transmit the signed transaction to the computing device 102 using the at least one optional short range wireless communication device 312 and the at least one optional antenna 318.

In exemplary embodiments, the external signature device 104 is paired with the computing device 102 before use and will only sign transaction requests originating from a properly paired computing device 102. In exemplary embodiments, the external signature device 104 is cryptographically paired with the computing device 102. In exemplary embodiments, the pairing occurs at setup of the external signature device 104. In exemplary embodiments, authentication (such as a password, PIN, biometric identifier, etc.) can be required to be input to the computing device 102 before pairing with an external signature device 104 is allowed. In exemplary embodiments, a single external signature device 104 can be paired with more than one computing device 102. In exemplary embodiments, a single computing device 102 can be paired with more than one external signature device 104.

In exemplary embodiments, the removable permission modules 106 are also paired with the external signature device 104 before use and the external signature device 104 will only sign transaction requests when a correctly paired removable permission module 106 is inserted. This aids against attempts by individuals to create and insert unauthorized removable permission modules 106 into the external signature device 104 in attempts to perform unauthorized transactions. In exemplary embodiments, the pairing between removable permission modules 106 and the computing device 104 includes storing hashes of the private key stored on the external signature device 104 on the permission modules 106 such that the hash stored on the permission modules 106 can be compared to a hash of the private key stored on the external signature device 104 such that only permission modules 106 with the correct hash are allowed to be used with the external signature device 106.

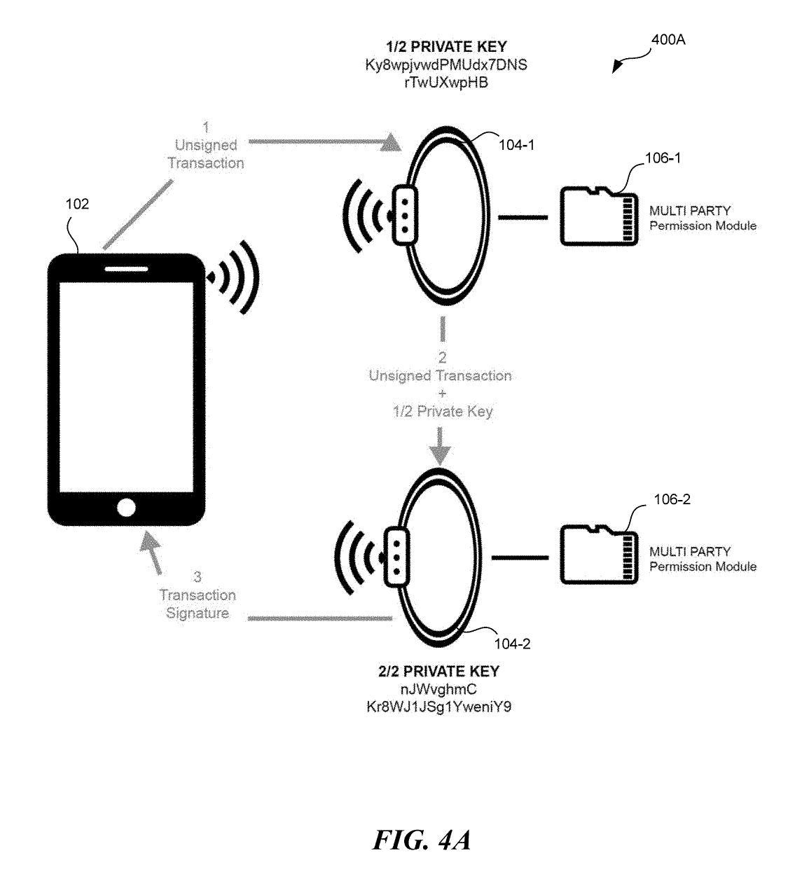

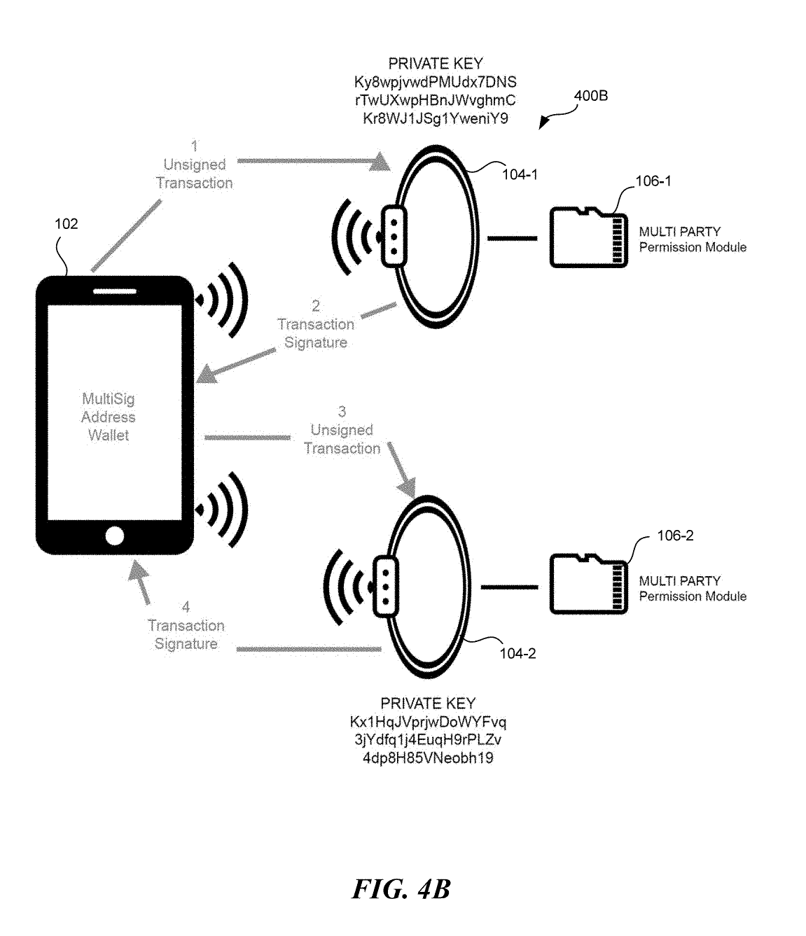

FIGS. 4A-4B are block diagrams of exemplary embodiments of systems 400 including a computing device 102 and a plurality of external signature devices 104 (including first external signature device 104-1 and second external signature device 104-2), where system 400A of FIG. 4A implements a multi-party key split methodology while system 400B of FIG. 4B implements a multi-party multiple signature (multi sig) methodology. Either of these methodology may be used in situations where it is desirable that multiple external signature devices 104 (which could be possessed by multiple parties) be required to sign/authorize a transaction (such as for large amounts).

FIG. 4A is a block diagram of an exemplary embodiment of a system 400A including a computing device 102 and a plurality of external signature devices 104 (including first external signature device 104-1 and second external signature device 104-2) using a multi-party key split methodology. In exemplary embodiments implementing a multi-party key split methodology, a first portion (such as first half) of a private key is stored on the first external signature device 104-1 and a second portion (such as a second half) of the private key is stored on a second external signature device 104-2. In exemplary embodiments, a transaction request is received at the first external signature device 104-1 from the computing device 102. In exemplary embodiments, this methodology requires that a trusted party split the private key when setting up the first external signature device 104-1 and the second external signature device 104-2.

If the transaction request is approved at the first external signature device 104-1, the first external signature device 104-1 sends the first portion of the private key to the second external signature device 104-2. If the transaction request is approved at the second external signature device 104-2, the second external signature device 104-2 signs the transaction request using the first portion of the private key received from the first external signature device 104-1 and using the second portion of the private key stored at the second external signature device 104-2. The second external signature device 104-2 then transmits the signed transaction to the computing device 102. In exemplary embodiments, more than two external signature devices 104 can be used, each having a portion of the private key and each needing to approve the transaction before all the portions of the private key can be used to sign the transaction to be provided back to the computing device 102.

In exemplary embodiments, each of the external signature devices 104 is configured to determine whether the unsigned details meet restrictions set by any removable permission module 106 inserted into the particular external signature device 104 before approving the transaction and providing the relevant portion of the private key to the next external signature device 104, providing a transaction signature based on the completed private key to the computing device 102, or signing the transaction with the completed private key. In addition, each external signature device 104 is optionally configured to determine whether the external signature device 104 is paired with the computing device 102 before approving the transaction and providing the relevant portion of the private key to the next external signature device or signing the transaction with the portions of the private key. In exemplary embodiments, each external signature device 104 is configured to at least one of not provide its portion of the private key, not provide the transaction signature based on the completed private key to the computing device 102, not sign the unsigned transaction using the portions of the private key, and generate an error message for the computing device 102 when it is determined that (1) the unsigned transaction details do not meet the restrictions set by any removable permission module 106 inserted into the particular external signature device 104; or (2) the particular external signature device 104 is not paired with the computing device 102 and/or other external signature devices 104.

FIG. 4B is a block diagram of an exemplary embodiment of a system 400B including a computing device 102 and a plurality of external signature devices 104 (including first external signature device 104-1 and second external signature device 104-2) using a multi-party multiple signature (multi sig) methodology. In exemplary embodiments implementing a multi-party multiple signature (multi sig) methodology, a first private key is stored on the first external signature device 104-1 and a second private key is stored on a second external signature device 104-2. In exemplary embodiments, a transaction request is received at both the first external signature device 104-1 and the second external signature device 104-2 from the computing device 102. In exemplary embodiments, this methodology does not require a trusted party to split the private key when setting up the first external signature device 104-1 and the second external signature device 104-2 because two separate keys are used.

If the transaction request is approved at the first external signature device 104-1, the first external signature device 104-1 either (1) transmits the first private key to the computing device 102 or (2) signs the transaction with the first private key and transmits the signed transaction to the computing device 102. If the transaction request is approved at the second external signature device 104-2, the second external signature device 104-2 either (1) transmits the second private key to the computing device 102 or (2) signs the transaction with the second private key and transmits the signed transaction to the computing device 102. In exemplary embodiments, more than two external signature devices 104 can be used, each having a separate private key and each needing to approve the transaction and send a signature or a signed transaction to the computing device 102 which is expecting a corresponding signature or a signed transaction signed by the corresponding private key from each of the external signature devices 104. In exemplary embodiments, the unsigned transaction is wirelessly sent from the computing device 102 to each external signature device 104, each external signature device 104 returns its signature or its signed transaction to the computing device 102, and the computing device 102 submits a single transaction to a network that includes each of the signatures from each of the external signature devices 104.

In exemplary embodiments, each of the external signature devices 104 is configured to determine whether the unsigned details meet restrictions set by any removable permission module 106 inserted into the particular external signature device 104 before approving the transaction and (1) providing its signature to the computing device 102 or (2) signing the transaction using its distinct private key and providing the signed transaction to the computing device 102. In addition, each external signature device 104 is optionally configured to determine whether the external signature device 104 is paired with the computing device 102 before approving the transaction and (1) providing its signature to the computing device 104 or (2) signing the transaction using its distinct private key and providing the signed transaction to the computing device 102. In exemplary embodiments, each external signature device 104 is configured to at least one of not transmit its signature, sign the unsigned transaction, and generate an error message for the computing device 102 when it is determined that (1) the unsigned transaction details do not meet the restrictions set by any removable permission module 106 inserted into the particular external signature device 104; or (2) the particular external signature device 104 is not paired with the computing device 102 and/or other external signature devices 104.

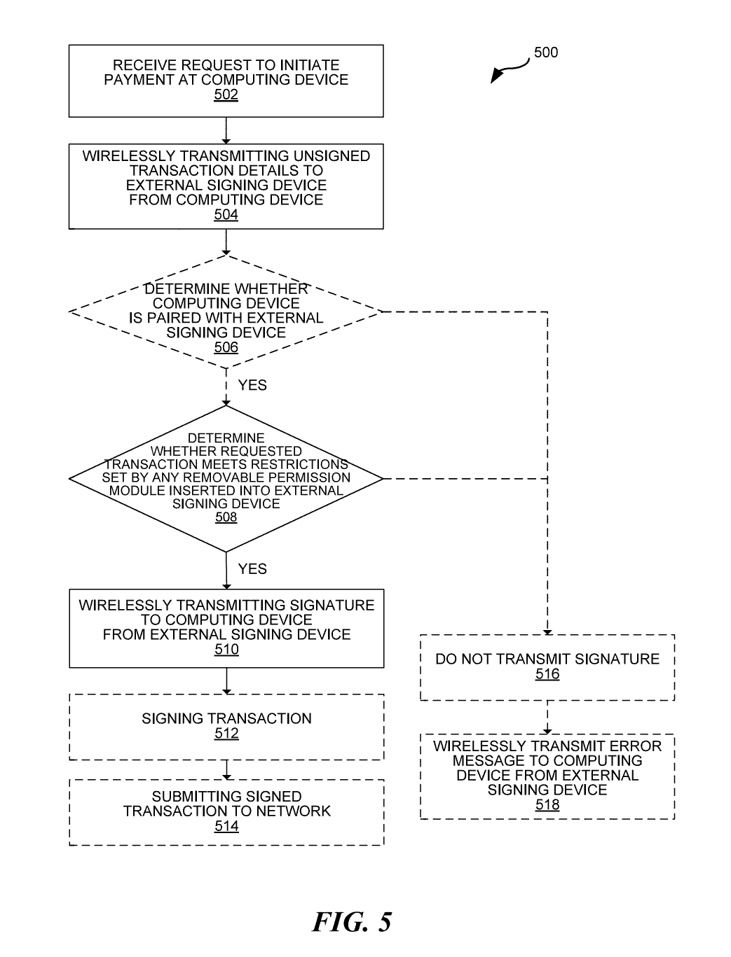

FIG. 5 is a flow diagram of an exemplary method 500 for signing transactions using an external signature device (such as external signature device 104) having removable permission modules 106. Exemplary method 500 begins at block 502 with receiving a request to initiate payment at a computing device. Exemplary method 500 proceeds to block 504 with wirelessly transmitting unsigned transaction details to an external signature device from the computing device. Exemplary method 500 proceeds to optional block 506 with determining whether the computing device is paired with the external signature device.

If the computing device is determined to be paired with the external signature device at block 506, exemplary method 500 proceeds to block 508 with determining whether the requested transaction meets restrictions set by any removable permission modules inserted into the external signature device. If the requested transaction meets the restrictions set by any removable permission modules inserted into the external signature device at block 508, exemplary method 500 proceeds to block 510 with wirelessly transmitting the signature (separately or as part of a signed transaction) to the computing device from the external signature device. Exemplary method 500 proceeds to optional block 512 with signing the unsigned transaction using the signature at the computing device. Exemplary method 500 proceeds to optional block 514 with submitting the signed transaction to a network. In exemplary embodiments where the signature is received from the external signature device as part of a signed transaction, the signed transaction received from the external signature device is submitted to the network.

If the computing device is determined not to be paired with the external signature device at block 506 or if the requested transaction is not determined to meet the restrictions set by any removable permission modules inserted into the external signature device at block 508, exemplary method 500 proceeds to optional block 516 with at least one of not transmitting the signature (separately or as part of a signed transaction) to the computing device. Exemplary method 500 proceeds to block 518 with wirelessly transmitting an error message to the computing device from the external signature device.

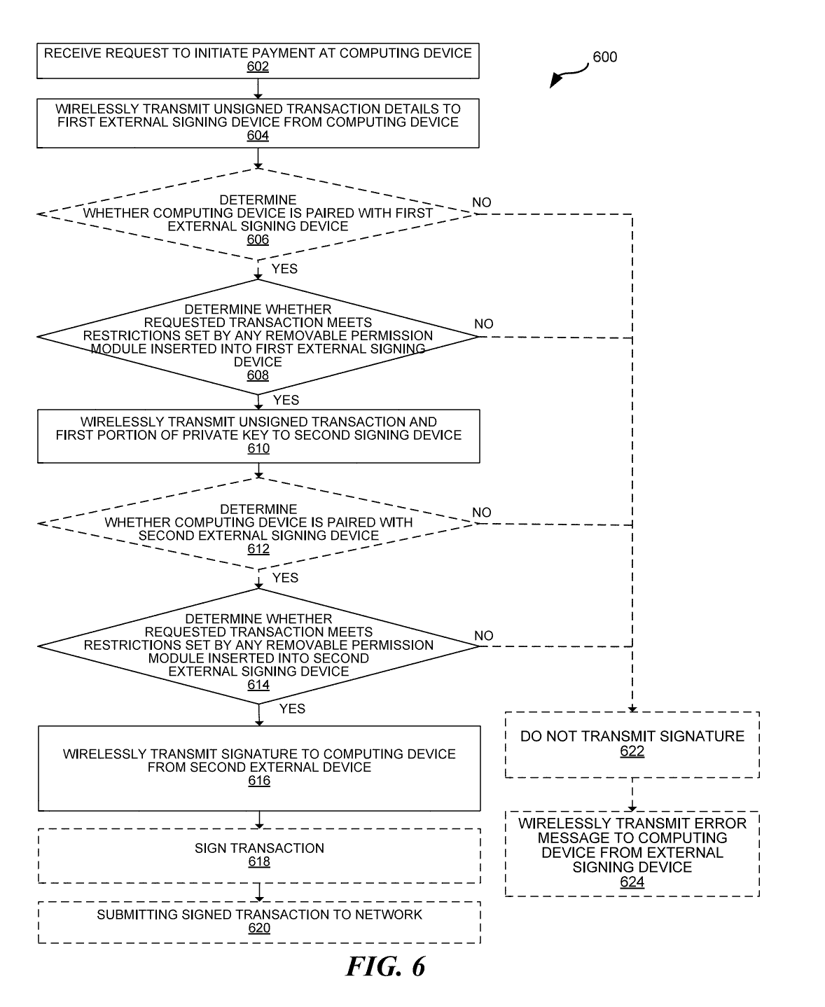

FIG. 6 is a flow diagram of an exemplary method 600 for signing transactions using two external signature devices (such as external signature devices 104) using a multi-party key split methodology. Exemplary method 600 begins at block 602 with receiving a request to initiate payment at a computing device. Exemplary method 600 proceeds to block 604 with wirelessly transmitting unsigned transaction details to an external signature device from the computing device. Exemplary method 600 proceeds to optional block 606 with determining whether the computing device is paired with the first external signature device.

If the computing device is determined to be paired with the first external signature device at optional block 606, exemplary method 600 proceeds to block 608 with determining whether the requested transaction meets restrictions set by any removable permission modules inserted into the first external signature device. If the requested transaction meets the restrictions set by any removable permission modules inserted into the first external signature device at block 606, exemplary method 600 proceeds to block 610 with wirelessly transmitting the unsigned transaction and a first portion of a private key to a second external signature device from the first external signature device. Exemplary method 600 proceeds to optional block 612 with determining whether the computing device is paired with the second external signature device.

If the computing device is determined to be paired with the second external signature device at optional block 612, exemplary method 600 proceeds to block 614 with determining whether the requested transaction meets restrictions set by any removable permission modules inserted into the second external signature device. If the requested transaction meets the restrictions set by any removable permission modules inserted into the second external signature device at block 614, exemplary method 600 proceeds to optional block 616 with wirelessly transmitting the completed signature (separately or as part of a signed transaction) to the computing device from the external signature device. Exemplary method 500 proceeds to optional block 618 with signing the unsigned transaction using the signature at the computing device. Exemplary method 600 proceeds to optional block 620 with submitting the signed transaction to a network. In exemplary embodiments where the completed signature is received from the external signature device as part of a signed transaction, the signed transaction received from the external signature device is submitted to the network.

If the computing device is determined not to be paired with the first external signature device at block 606, if the requested transaction is not determined to meet the restrictions set by any removable permission modules inserted into the first external signature device at block 608, if the computing device is determined not to be paired with the second external signature device at block 612, or if the requested transaction is not determined to meet the restrictions set by any removable permission modules inserted into the second external signature device at block 614, exemplary method 600 proceeds to block 622 with at least one of not transmitting the completed signature (separately or as part of a signed transaction) to the computing device and not signing the transmission with the completed signature. Exemplary method 600 proceeds to block 624 with wirelessly transmitting an error message to the computing device from at least one of the first external signature device or the second external signature device.

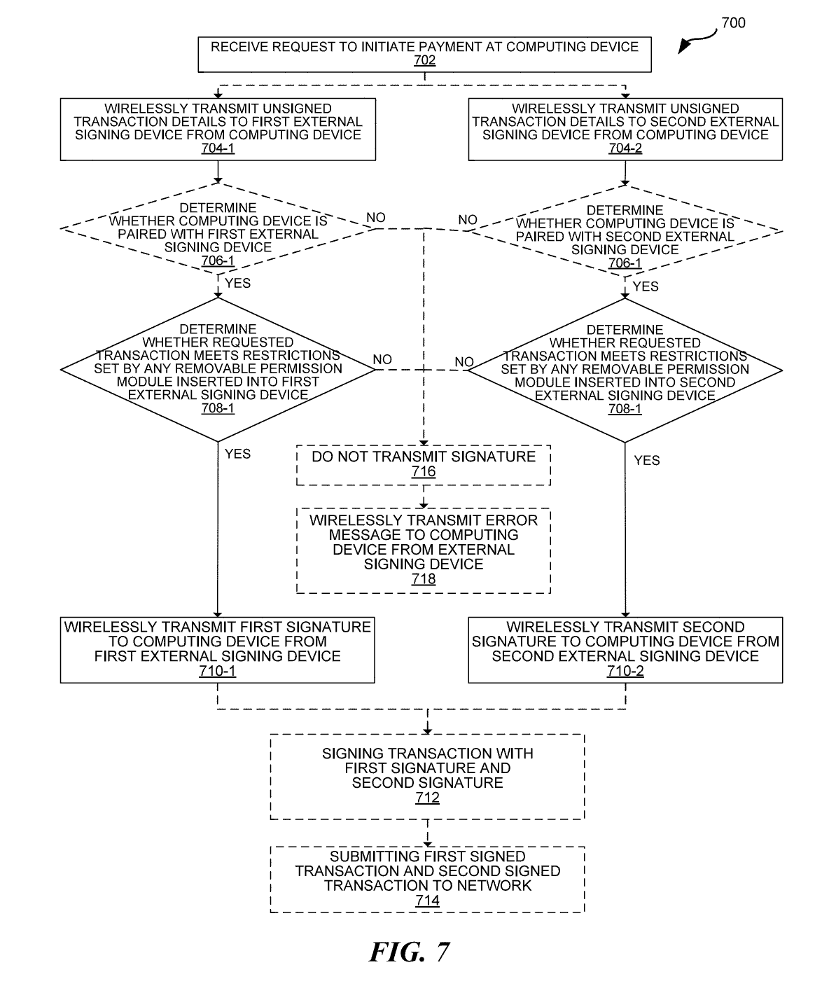

FIG. 7 is a flow diagram of an exemplary method 700 for signing transactions using two external signature devices (such as external signature devices 104) using a multi-party multiple signature (multi sig) methodology. Exemplary method 700 begins at block 702 with receiving a request to initiate payment at a computing device. Exemplary method 700 includes two different paths, a first for a first external device and a second for a second external device.

With reference to the first path, exemplary method 700 proceeds from block 702 to block 704-1 with wirelessly transmitting unsigned transaction details to a first external signature device from the computing device. Exemplary method 700 proceeds to optional block 706-1 with determining whether the computing device is paired with the first external signature device. If the computing device is determined to be paired with the first external signature device at block 706-1, exemplary method 700 proceeds to block 708-1 with determining whether the requested transaction meets restrictions set by any removable permission modules inserted into the first external signature device. If the requested transaction meets the restrictions set by any removable permission modules inserted into the first external signature device at block 708-1, exemplary method 700 proceeds to block 710-1 with wirelessly transmitting the first signature (separately or as part of a first signed transaction) to the computing device from the first external signature device.

With reference to the second path, exemplary method 700 proceeds from block 702 to block 704-2 with wirelessly transmitting unsigned transaction details to a second external signature device from the computing device. Exemplary method 700 proceeds to optional block 706-2 with determining whether the computing device is paired with the second external signature device. If the computing device is determined to be paired with the second external signature device at block 706-2, exemplary method 700 proceeds to block 708-2 with determining whether the requested transaction meets restrictions set by any removable permission modules inserted into the second external signature device. If the requested transaction meets the restrictions set by any removable permission modules inserted into the second external signature device at block 708-2, exemplary method 700 proceeds to block 710-2 with wirelessly transmitting the second signature (separately or as part of a second signed transaction) to the computing device from the second external signature device.

Exemplary method 700 proceeds from blocks 710-1 and 710-2 to optional block 712 with signing the unsigned transaction using the first signature and the second signature at the computing device. Exemplary method 700 proceeds to optional block 714 with submitting the first signed transaction and the second signed transaction to a network. In exemplary embodiments where the signatures are received from the external signature device, a transaction is first signed by the computing device using the signatures before the signed transaction is submitted to the network. If the computing device is determined not to be paired with the first external signature device at block 706-1 or if the requested transaction is not determined to meet the restrictions set by any removable permission modules inserted into the first external signature device at block 708-2, exemplary method 700 proceeds to optional block 716 with at least one of not transmitting the signature (separately or as part of a signed transaction) to the computing device and not signing the transaction and to optional block 718 with wirelessly transmitting an error message to the computing device from the first external signature device. If the computing device is determined not to be paired with the second external signature device at block 706-2 or if the requested transaction is not determined to meet the restrictions set by any removable permission modules inserted into the second external signature device at block 708-2, exemplary method 700 proceeds to optional block 716 with at least one of not transmitting the signature (separately or as part of a signed transaction) to the computing device and not signing the transaction and to optional block 718 with wirelessly transmitting an error message to the computing device from the first external signature device.

The techniques introduced here can be embodied as special-purpose hardware (such as circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Computer System Overview

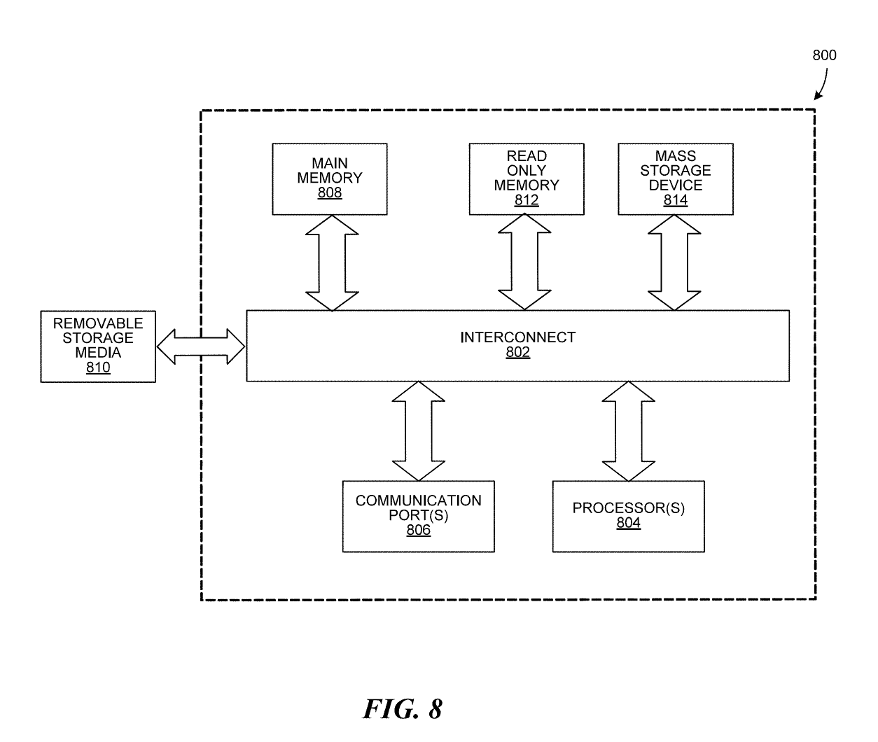

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 8 is an example of a computer system 800 with which embodiments of the present disclosure may be utilized. According to the present example, the computer system 800 includes an interconnect 802, at least one processor 804, at least one communication port 806, at least one main memory 808, at least one removable storage media 810, at least one read only memory 812, and at least one mass storage device 814.

The at least one processor 804 can be any known processor. The at least one communication port 806 can be or include, for example, any of an RS-232 port for use with a modem-based dialup connection, a 10/100 Ethernet port, or a Gigabit port using copper or fiber. The nature of the at least one communication port 806 may be chosen depending on a network such a Local Area Network (LAN), Wide Area Network (WAN), or any network to which the computer system 800 connects. The at least one main memory 808 can be Random Access Memory (RAM), or any other dynamic storage device(s) commonly known in the art. The at least one read only memory 812 can be any static storage device(s) such as Programmable Read Only Memory (PROM) chips for storing static information such as instructions for the at least one processor 80.

The at least one mass storage device 814 can be used to store information and instructions. For example, hard disks such as the Adaptec® family of SCSI drives, an optical disc, an array of disks such as RAID, such as the Adaptec family of RAID drives, or any other mass storage devices may be used. Interconnect 802 can be or include one or more buses, bridges, controllers, adapters, and/or point-to-point connections. Interconnect 802 communicatively couples the at least one processor 804 with the other memory, storage, and communication blocks. Interconnect 802 can be a PCI/PCI-X or SCSI based system bus depending on the storage devices used. The at least one removable storage media 810 can be any kind of external hard-drives, floppy drives, Compact Disc-Read Only Memory (CD-ROM), Compact Disc-Re-Writable (CD-RW), Digital Video Disc-Read Only Memory (DVD-ROM).

The components described above are meant to exemplify some types of possibilities. In no way should the aforementioned examples limit the disclosure, as they are only exemplary embodiments.

Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

In conclusion, the present disclosure provides novel systems, methods, and arrangements for creating, redeeming, and trading multiple security assets. While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a computing device;
a first external signing device wirelessly communicatively coupled to the computing device;
wherein the computing device is configured to:
receive a request to initiate payment from a mobile wallet; and
wirelessly transmit unsigned transaction details to the first external signing device; and
wherein the first external signing device is configured to:
determine whether the unsigned transaction details meet restrictions set by any removable permission module inserted into the first external signing device; and
when the unsigned transaction details meet the restrictions set by any removable permission module inserted into the first external signing device:
wirelessly transmit a first signature to the computing device.

2. The system of claim 1, further comprising:
wherein the computing device is configured to:
sign the unsigned transaction using the first signature to generate a first signed transaction; and
submit the first signed transaction to a network.

3. The system of claim 2, wherein the computing device is configured to submit the first signed transaction to the network by being configured to:
wirelessly transmit the first signed transaction from the computing device to a payment terminal using near field communication (NFC).

4. The system of claim 1, further comprising:
wherein the first external signing device is configured to:
sign the unsigned transaction using the first signature to generate a first signed transaction; and
wirelessly transmit the first signed transaction to the computing device, wherein the first signature is wirelessly transmitted to the computing device in the first signed transaction; and
wherein the computing device is configured to:
submit the first signed transaction to a network.

5. The system of claim 4, wherein the computing device is configured to submit the first signed transaction to the network by being configured to:
wirelessly transmit the first signed transaction from the computing device to a payment terminal using near field communication (NFC).

6. The system of claim 1, wherein the first external signing device is configured to, when the unsigned transaction details do not meet the restrictions set by any removable permission module inserted into the first external signing device, at least one of:
not wirelessly transmit the first signature to the computing device;
not sign the transaction; and
wirelessly transmit an error message to the computing device.

7. The system of claim 1, wherein the first external signing device is configured to:
determine whether the computing device is paired with the first external signing device;
only wirelessly transmit the first signature to the computing device when the computing device is determined to be paired with the first external signing device.

8. The system of claim 7, wherein the first external signing device is configured to, when the computing device is not determined to be paired with the first external signing device, at least one of:
not wirelessly transmit the first signature to the computing device;
not sign the transaction; and
wirelessly transmit an error message to the computing device.

9. The system of claim 1, further comprising:
a second external signing device wirelessly communicatively coupled to the computing device;
wherein the computing device is further configured to:
wirelessly transmit the unsigned transaction details to the second external signing device;
wherein the second external signing device is configured to:
determine whether the unsigned transaction details meet restrictions set by any removable permission module inserted into the second external signing device;
when the unsigned transaction details meet the restrictions set by any removable permission module inserted into the second external signing device:
wirelessly transmit a second signature to the computing device.

10. The system of claim 1, wherein the computing device is a mobile computing device.

11. A method comprising:
receiving a request to initiate payment from a mobile wallet at a computing device;
wirelessly transmitting unsigned transaction details to a first external signing device from the computing device;
determining whether the unsigned transaction details meet restrictions set by any removable permission module inserted into the first external signing device; and
when the unsigned transaction details meet the restrictions set by any removable permission module inserted into the first external signing device:
wirelessly transmit a first signature to the computing device from the first external signing device.

12. The method of claim 11, further comprising:
signing the unsigned transaction using the first signature to generate a first signed transaction at the computing device or the first external signing device; and
submitting the first signed transaction to a network from the computing device.

13. The method of claim 12, wherein submitting the first signed transaction to the network includes:
wirelessly transmitting the first signed transaction from the computing device to a payment terminal using near field communication (NFC).

14. The method of claim 11, further comprising:
when the unsigned transaction details do not meet the restrictions set by any removable permission module inserted into the first external signing device, at least one of:
not wirelessly transmitting the first signature from the first external signing device to the computing device;
not signing the transaction; and
wirelessly transmitting an error message from the first external signing device to the computing device.

15. The method of claim 11, further comprising:
determining whether the computing device is paired with the first external signing device; and
only wirelessly transmitting the first signature to the computing device when the computing device is determined to be paired with the first external signing device.

16. The method of claim 15, further comprising:
when the computing device is not determined to be paired with the first external signing device, at least one of:
not wirelessly transmitting the first signature to the computing device;
not signing the transaction; and
wirelessly transmitting an error message to the computing device from the first external signing device.

17. The method of claim 11, further comprising:
wireless transmitting the unsigned transaction details to a second external signing device from the computing device;
determining whether the unsigned transaction details meet restrictions set by any removable permission module inserted into the second external signing device;
when the unsigned transaction details meet the restrictions set by any removable permission module inserted into the second external signing device:
wirelessly transmitting a second signature to the computing device from the second external signing device.

18. The method of claim 11, wherein the computing device is a mobile computing device.

19. An external signing device comprising:
at least one processor;
at least one memory communicatively coupled to the at least one processor;
at least one wireless communication device communicatively coupled to the at least one processor and an antenna;
at least one removable permission module slot communicatively coupled to the at least one processor;
wherein the at least one wireless communication device is configured to wirelessly receive unsigned transaction details from a computing device through the antenna;
wherein the at least one processor is configured to:
receive the unsigned transaction details from the at least one wireless communication device;
determine whether the unsigned transaction details meet restrictions set by any removable permission module inserted into the at least one removable permission module slot;
when the unsigned transaction details meet the restrictions set by any removable permission module inserted into the at least one removable permission module slot, cause the at least one wireless communication device to wirelessly transmit a first signature to the computing device.

20. The external signing device of claim 19, wherein the at least one wireless communication device is a near field communication (NFC) radio.
